(19) United States
(12) Patent Application Publication
(10) Pub. No.: US 2010/0134770 A1
(43) Pub. Date: Jun. 3, 2010

(54) EXPOSURE APPARATUS AND METHOD FOR MANUFACTURING DEVICE

(75) Inventor: Tomohiro Okamoto, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/628,934

(22) Filed: Dec. 1, 2009

(30) Foreign Application Priority Data
Dec. 3, 2008 (JP) 2008-308733

(51) Int. Cl. G03B 27/52

(52) U.S. Cl. 355/30; 355/55; 355/77

(57) ABSTRACT

An exposure apparatus projects a pattern of an original plate onto a substrate through a projection optical system to expose the substrate to the pattern. The exposure apparatus includes a supporting member configured to support an optical element of the projection optical system along the direction of gravitational force, and position adjustment mechanisms disposed at least two different positions on the supporting member and configured to press the optical element to displace the optical element relative to the supporting member. The pressing force of the position adjustment mechanisms against the optical element is changed to move contact positions between the position adjustment mechanisms and the optical element to displace the optical element relative to the supporting member. Thus, optical performance adjustment of the optical element is performed, and then all the position adjustment mechanisms are made in non-contact state with the optical element.

### BACKGROUND OF THE INVENTION

1. Field of the Invention

The present invention relates to an exposure apparatus, which projects a pattern of an original plate through a projection optical system to expose a substrate to the pattern.

2. Description of the Related Art

In manufacturing a semiconductor device formed with an ultra-minute pattern, a semiconductor exposure apparatus reduces and projects an image of a circuit pattern of an original plate (a reticle) onto a substrate (a wafer) to print the circuit pattern thereon. Improvement in resolution of exposure apparatuses has been achieved to meet demands for forming finer minute patterns to further increase the integration of semiconductor devices.

To improve the resolution of an exposure apparatus, it is necessary to improve the performance of a projection optical system for reducing and projecting an image of a pattern of the original plate onto the substrate. To improve the performance of the projection optical system, it is necessary to improve the positional accuracy of each optical element in a lens barrel, which includes a plurality of optical elements.

Japanese Patent Application Laid-Open No. 2001-124968 discusses a method for assembling a projection optical system employing a cell structure to position each optical element with high precision in assembling process to reduce measured aberration within tolerance. After assembling the projection optical system, it becomes necessary to correct variation in optical performance caused by external factors such as shock to the lens barrel or temperature change during transportation or operation, thus position adjustment of optical elements is required.

Each of Japanese Patent Application Laid-Open No. 2001-343575, Japanese Patent Application Laid-Open No. 2002-131605, and Japanese Patent Application Laid-Open No. 2005-175271 discusses a method for connecting actuators to an optical element through displacement-transmitting members so that the optical element is displaced by displacement of the actuators to perform position adjustment of the optical element after assembling process.

With each optical element constituting a high-precision optical system, it is also necessary to reduce degradation in optical performance caused by deformation of each element due to external force or birefringent as much as possible. Japanese Patent Publication No. 4-69885 discusses a method for fixing an optical element to a supporting member by filling a space between the optical element and the supporting member with an adhesive.

Adhesive-based fixing methods can reduce external force applied to an optical element to greater extent than that of mechanical fixing methods, and thus reduce deformation generated when assembling the optical element. Further, this method for fixing an optical element by filling a space between the optical element and the supporting member with an adhesive is simpler and more space-saving than mechanical fixing methods. Therefore, the method can be used without imposing severe space restrictions when considering arrangement of an optical element in optical design.

However, with the method for fixing an optical element by filling a space between the optical element and the supporting member with an adhesive, the adhesive changes its hardness and volume as it hardens. Accordingly, external force is applied to the optical element to cause a positional deviation, deformation, or birefringent of the optical element.

With an exposure apparatus employing short-wavelength laser as a light source, when the adhesive is irradiated with dispersion light, gas is emitted therefrom. The emitted gas may contaminate the surface of the optical element, which may cause degradation in transmissivity and optical characteristics. Further, when the adhesive is irradiated with dispersion light in the projection optical system, characteristics of the adhesive may change and cause a positional deviation of the optical element.

When the actuators are directly connected to the optical element, external force applied to the optical element may change as the optical element is driven by displacement of the actuators. Accordingly, a change in optical characteristics due to the drive may arise.

In each of Japanese Patent Application Laid-Open No. 2001-343575, Japanese Patent Application Laid-Open No. 2002-131605, and Japanese Patent Application Laid-Open No. 2005-175271, since the actuators are connected to the optical element through displacement-transmitting members, the force by displacement of the actuators is not directly applied to the optical element but is reduced by the displacement-transmitting members. However, the lens barrel increases in size because of the displacement-transmitting members included therein, and the optical element is subjected to external force since it is fixed to the supporting member.

### SUMMARY OF THE INVENTION

The present invention is directed to an exposure apparatus, which reduces influence of external force on an optical element to stabilize optical performance.

According to an aspect of the present invention, an exposure apparatus for projecting a pattern of an original plate to expose a substrate thereto through a projection optical system includes a supporting member configured to support an optical element of the projection optical system along the direction of gravitational force, and position adjustment mechanisms disposed at a plurality of positions on the supporting member and configured to press the optical element to displace the optical element relative to the supporting member, wherein after the pressing force of the position adjustment mechanisms against the optical element is changed to move contact positions between the position adjustment mechanisms and the optical element to displace the optical element relative to the supporting member and optical performance measurement of the optical element is performed, all the position adjustment mechanisms are made in non-contact state with the optical element.

According to another aspect of the present invention, an exposure apparatus for projecting a pattern of an original plate to expose a substrate thereto through a projection optical system includes a supporting member configured to support an optical element of the projection optical system along the direction along the gravitational force, position adjustment mechanisms disposed at a plurality of positions on the supporting member and configured to press the optical element to displace the optical element relative to the supporting member, and position detection units configured to detect an amount of movement of the optical element, wherein the position adjustment mechanisms are provided with two different contact positions with the optical element to displace the optical element in both positive and negative directions, and wherein the contact positions between the position adjustment mechanisms and the optical element are moved to press the optical element to displace the optical element relative to the supporting member, thus performing optical performance adjustment of the optical element, and then all the position adjustment mechanisms are brought into non-contact state with the optical element.

According to yet another aspect of the present invention, an exposure apparatus for projecting a pattern of an original plate to expose a substrate thereto through a projection optical system includes a supporting member configured to support an optical element of the projection optical system along the direction of gravitational force, position adjustment mechanisms disposed at a plurality of positions on the supporting member and configured to press the optical element to displace the optical element relative to the supporting member, position detection units each configured to detect an amount of movement of the optical element; and coupling members each configured to connect the position adjustment mechanisms with the optical element, wherein after contact positions between the position adjustment mechanisms and the optical element are moved in one and opposite directions to respectively press and pull the optical element to displace the optical element relative to the supporting member, and thus optical performance adjustment of the optical element is performed, all the position adjustment mechanisms are brought into non-contact state with the optical element, and the coupling members are bent.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a partial configuration diagram of an exposure apparatus according to a first exemplary embodiment of the present invention.

FIG. 2 is a partial configuration diagram of an exposure apparatus according to a second exemplary embodiment of the present invention.

FIG. 3 is a partial configuration diagram of an exposure apparatus according to a third exemplary embodiment of the present invention.

FIG. 4 is a partial configuration diagram of an exposure apparatus according to a fourth exemplary embodiment of the present invention.

FIG. 5 is a partial configuration diagram of an exposure apparatus according to a fifth exemplary embodiment of the present invention.

FIG. 6 is a partial configuration diagram of the exposure apparatus according to the fifth exemplary embodiment of the present invention.

FIG. 7 is a partial configuration diagram of an exposure apparatus according to a sixth exemplary embodiment of the present invention.

FIG. 8 is an overall configuration diagram of an exposure apparatus according to an exemplary embodiment of the present invention.

### DESCRIPTION OF THE EMBODIMENTS

Various exemplary embodiments, features, and aspects of the invention will be described in detail below with reference to the drawings.

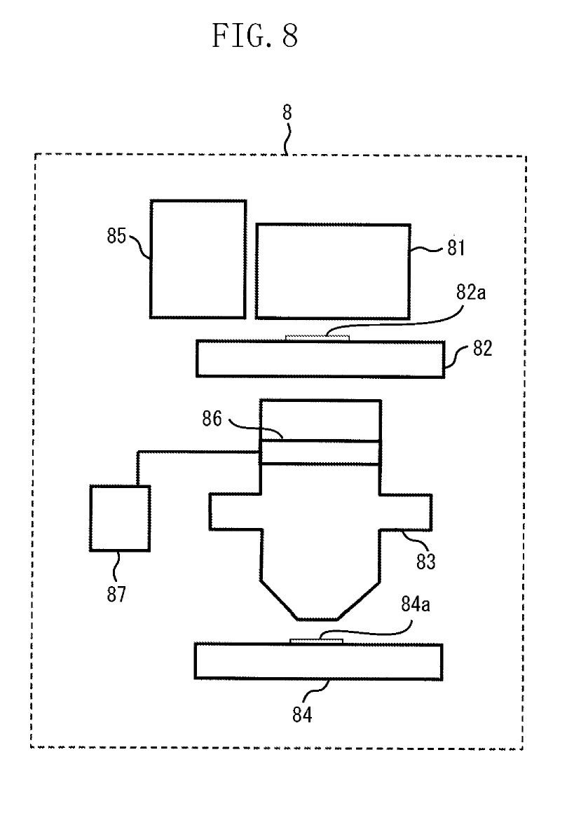

FIG. 8 is an overall configuration diagram of an exposure apparatus according to a first exemplary embodiment of the present invention. An exposure apparatus 8 according to the first exemplary embodiment includes a reticle 82a (an original plate), a wafer 84a (a substrate), a projection optical system 83, an irradiation optical system 81, a reticle stage 82, a wafer stage 84, an aberration measurement unit 85, an optical element position adjustment device 86, and a position adjustment control unit 87. The exposure apparatus 8 projects a pattern of the reticle 82a onto the wafer 84a through the projection optical system 83 to expose the wafer 84a to the pattern. The projection optical system 83 includes the optical element position adjustment device 86 configured to adjust the position of an optical element based on a command value sent by the position adjustment control unit 87.

The irradiation optical system 81 includes an illumination light source to illuminate the reticle 82a. The reticle stage 82 holds and moves the reticle 82a. The wafer stage 84 holds and moves the wafer 84a. The aberration measurement unit 85 includes an interferometer and a wave-front aberration calculation unit to measure aberration of the projection optical system 83.

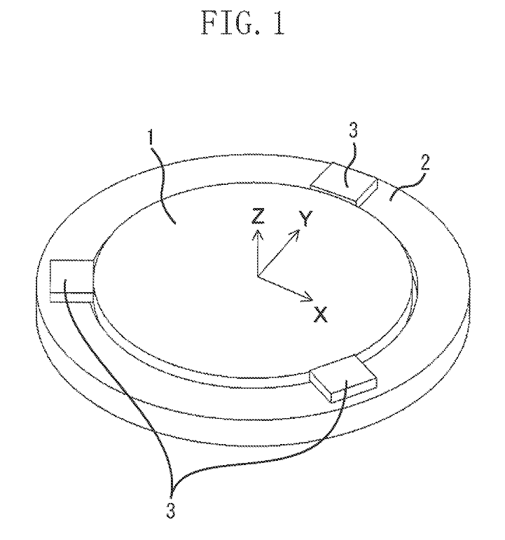

FIG. 1 is a partial configuration diagram of the exposure apparatus according to the first exemplary embodiment of the present invention. The projection optical system 83 includes a supporting member 2, which supports an optical element 1 in the direction of gravitational force. The optical element 1 is a lens or a mirror. The direction of gravitational force in FIG. 1 is negative direction of the Z axis. A force generated by its own weight is exerted to the optical element 1.

Position adjustment mechanisms 3 are disposed at a plurality of positions on the supporting member 2 to press the optical element 1 to displace the optical element 1 relative to the supporting member 2. As the position adjustment mechanisms 3 press the optical element 1 toward its central axis, the optical element 1 is displaced in moving directions of the contact positions with the position adjustment mechanisms 3.

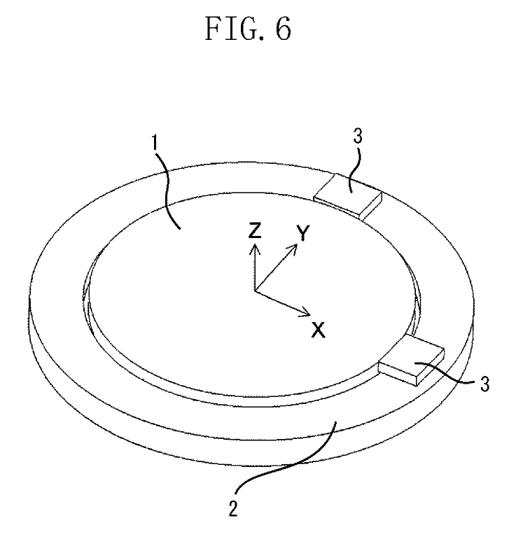

The position adjustment mechanisms 3 are disposed to the supporting member 2 at three different positions at equal intervals, i.e., at intervals of 120 degrees along the circumference of the optical element 1. Although the position adjustment mechanisms 3 are disposed at two different positions in a fifth exemplary embodiment illustrated in FIG. 6 (described below), the position adjustment mechanisms 3 may be disposed at three or more positions. For example, the position adjustment mechanisms 3 may be disposed at four different positions at equal intervals, i.e., at intervals of 90 degrees.

The position adjustment mechanisms 3 may be arranged at three or more different positions not at equal intervals but at different intervals. If all the position adjustment mechanisms 3 are positioned not within 180 degrees along the circumference of the optical element 1, the position adjustment mechanisms 3 can displace the optical element 1 within a positional range defined on a plane of the optical element 1 perpendicularly intersecting the direction of gravitational force.

Although the position adjustment mechanisms 3 are attached to the supporting member 2, the position adjustment mechanisms 3 can also be attached to a member for supporting the supporting member 2. The member for supporting the supporting member 2 on which the position adjustment mechanisms 3 are attached may support the supporting member 2 directly or indirectly via a plurality of supporting members in between.

The procedure for displacing the optical element 1 relative to the supporting member 2 by using the position adjustment mechanisms 3 in the exposure apparatus according to the first exemplary embodiment of FIG. 1 is described below.

The pressing force of the position adjustment mechanisms 3 against the optical element 1 is changed by moving the contact positions between the position adjustment mechanisms 3 and the optical element 1 to displace the optical element 1 relative to the supporting member 2. More specifically, as the position adjustment mechanisms 3 press the optical element 1 toward its central axis in response to an input from a control unit (not illustrated), the contact positions with the optical element 1 move.

The input can be a voltage, current, force, heat, or light used as a command value supplied from the control unit (not illustrated) to move the contact positions. The input can be selected depending on the position adjustment mechanisms 3 to be used.

When an input is given to one position adjustment mechanism 3 not in contact with the optical element 1 to move the position adjustment mechanism 3 toward the optical element 1, the position adjustment mechanism 3 comes in contact with the optical element 1. After the position adjustment mechanism 3 comes in contact with the optical element 1, if the contact position between the position adjustment mechanism 3 and the optical element 1 is further kept moving toward the optical element 1, the position adjustment mechanism 3 receives a frictional force produced between the optical element 1 and the supporting member 2 as a resistance.

If the contact position between the position adjustment mechanism 3 and the optical element 1 is moved with a force exceeding the frictional force until the position adjustment mechanism 3 presses the optical element 1, the optical element 1 is displaced relative to the supporting member 2 in the direction in which the contact position therebetween has moved in a plane perpendicularly intersecting the direction of gravitational force. Other position adjustment mechanisms 3 are retracted in advance so that the optical element 1 does not come into contact therewith not to disturb the movement of the optical element 1.

Upon completion of position adjustment of the optical element 1 in this way, all the position adjustment mechanisms 3 are made to be not in contact with the optical element 1. More specifically, after moving the optical element 1, the contact positions between the position adjustment mechanisms 3 and the optical element 1 are moved in a direction opposite to the direction in which the optical element 1 was moved. Thus, the position adjustment mechanisms 3 are not in contact with the optical element 1.

In this way, the force, which is applied to the optical element 1 to move the optical element 1 while the position adjustment mechanism 3 is in contact with the optical element 1, is released. Accordingly, deformation and birefringent of the optical element 1 are also released.

Before and after the optical performance adjustment of the optical element 1, there may be a very small change in the force generated between the optical element 1 and the supporting member 2 by the weight of the optical element 1. With conventional position adjustment mechanisms with which the optical element 1 is fixed to the supporting member 2 using a fixing member, the force applied to the optical element 1 through the fixing member during adjustment causes deformation and birefringent of the optical element 1.

In the first exemplary embodiment illustrated in FIG. 1, since there is no force applied to the optical element 1 through a fixing member, deformation and birefringent produced due to the adjustment are very small. Thus, optical performance can be adjusted with high precision.

With conventional optical element supporting apparatuses with which external force by adhesive or mechanical fixation is applied to the optical element 1, if the external force changes by external factors such as shock and temperature change or creeping of a member, a positional deviation, deformation, or birefringent of the optical element 1 may occur.

In the first exemplary embodiment illustrated in FIG. 1, since external force for fixation is not applied to the optical element 1, the force applied to the optical element 1 remains stable over long periods. Therefore, deformation and a variation in birefringent of the optical element 1 are very small. Thus, stable optical performance over long periods can be obtained.

Thermal actuators having a temperature control unit may be used as the position adjustment mechanisms 3 of FIG. 1. The thermal actuators may move contact positions between the thermal actuators and the optical element 1 by a volume change in the thermal actuators caused by a temperature change therein.

When the actuators are 10-mm materials having a linear expansion coefficient of 10⁻⁵ 1/K respectively, the actuators change in size by 100 nm for a temperature change of 1K. Therefore, the use of thermal actuators having a temperature control unit as the position adjustment mechanisms 3 can attain both downsizing and high resolution. If necessary, the use of a material having a low heat expansion (with a linear expansion coefficient of less than 10⁻⁶ 1/K) as the supporting member 2 reduces influence by a volume change due to a temperature change of the supporting member 2.

As the position adjustment mechanisms 3 illustrated in FIG. 1, piezoelectric actuators, pressure actuators, motors, or screws may be used. However, there may be a case where it is difficult to arrange them in the vicinity of the optical element 1 and to achieve the required accuracy when using them as the position adjustment mechanisms 3.

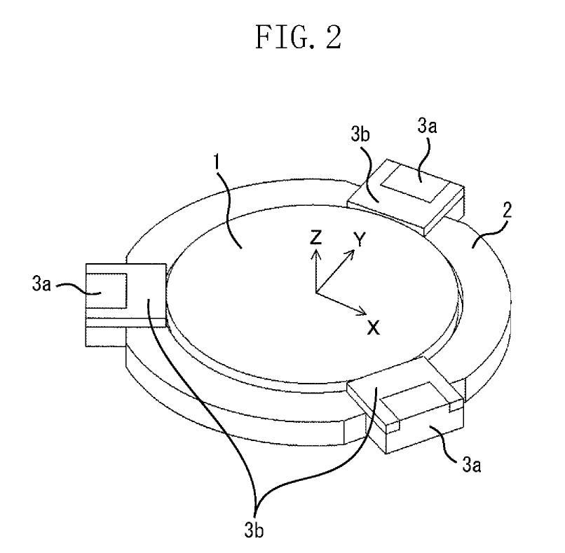

In that case, like an exposure apparatus according to a second exemplary embodiment of the present invention illustrated in FIG. 2, the position adjustment mechanism 3 may be composed of an actuator 3a and a link mechanism 3b, which changes magnification and direction of displacement of the actuator 3a. The link mechanism 3b is configured to come in contact with the optical element 1 and designed to change magnification and direction of displacement of the actuator 3 as required.

If the link mechanism 3b is designed such that the actuator 3a can be detached from outside of the lens barrel, the actuator 3a can be replaced if any trouble occurs, thus improving the reliability of the position adjustment mechanisms 3.

For the link mechanisms 3b illustrated in FIG. 2, parts having hinges and joints formed thereon by processing a plurality of notches, holes, and slots can be used to change magnification and direction of displacement of the actuators 3a.

In position adjustment of the optical element 1 illustrated in FIG. 1, when displacing the optical element 1 on the supporting member 2, frictional force produced between the optical element 1 and the supporting member 2 serves as a resistance to the position adjustment mechanisms 3. To reduce the resistance to allow the optical element 1 to be displaced by a smaller force to improve the accuracy of position adjustment, it may be useful to reduce the friction coefficient and the weight of the optical element 1.

To reduce the friction coefficient, it may be useful to form a slidable fixing film or apply a liquid film on the contact surfaces between the optical element 1 and the supporting member 2.

To reduce the weight of the optical element 1, it may be useful to apply a force to the optical element 1 in the opposite direction of gravitational force. Methods for applying a force to the optical element 1 in the opposite direction of gravitational force includes a method for pulling the optical element 1 in the opposite direction of gravitational force, a method for supplying a fluid such as a liquid and a gas to apply a buoyant force and pressure to the optical element 1, and a method for applying magnetic force to the optical element 1.

With the method for pulling the optical element 1 in the opposite direction of gravitational force, wires or coil springs are connected to the optical element 1 to apply a force thereto to prevent external force from being applied to any other direction than the opposite direction of gravitational force.

With the method for supplying a fluid, a seal structure is provided to prevent the fluid supplied between the optical element 1 and the supporting member 2 from flowing in an unwanted direction, and a force is applied in the opposite direction of gravitational force.

With the method for applying magnetic force to the optical element 1, a target for receiving magnetic force is attached to the optical element 1, and a force is applied to the optical element 1 in the opposite direction of gravitational force via the target.

Pressure generated by supplying the fluid and magnetic force can also be used as the position adjustment mechanisms 3 that can displace the optical element 1 relative to the supporting member 2 without coming in contact with the optical element 1. This method is used on a premise that a force by pressure and magnetic force is applied in a direction perpendicularly intersecting the direction of gravitational force.

If pulling and pressing forces can be applied by pressure and magnetic force, a position adjustment mechanism 3 can displace the optical element 1 in both positive and negative directions. In this case, the position adjustment mechanisms 3 disposed at least two different positions can displace the optical element 1 in a plane perpendicularly intersecting the direction of gravitational force.

To displace the optical element 1 illustrated in FIG. 1, it is necessary to determine a moving direction and an amount of movement. It is also necessary to check whether or not optical performance adjustment has been made to obtain predetermined conditions. Therefore, the exposure apparatus according to the present exemplary embodiment includes position detection units configured to detect an amount of movement of the optical element 1.

The position detection units measure aberration of the projection optical system 83 illustrated in FIG. 8, calculates the amount of movement of the optical element 1 necessary to settle the aberration within a tolerance, and displaces the optical element 1 relative to the supporting member 2.

More specifically, the position detection units measure aberration of the projection optical system 83 ready for operation as an assembly composed of a plurality of optical elements 1. After measuring aberration of the projection optical system 83 by using the aberration measurement unit 85, the position detection units displace the optical element 1 relative to the supporting member 2 so that the aberration falls within the tolerance.

If aberration is measured after this position adjustment of the optical element 1 is performed, it is possible to check whether or not the aberration falls within the tolerance. If the aberration does not fall within the tolerance, the position detection units displace again the optical element 1 relative to the supporting member 2. When the position detection units repetitively perform this aberration measurement and relative movement of the optical element 1, the aberration can be settled within the tolerance.

With the above-mentioned exposure apparatus according to the first exemplary embodiment, it is necessary to give an input to the position adjustment mechanisms 3, which displace the optical element 1 to a target position. However, before performing position adjustment of the optical element 1 by using the position adjustment mechanism 3 for the first time, the position of the optical element 1 within a positional range defined relative to the supporting member 2 is not known.

Since clearances between the position adjustment mechanisms 3 and the optical element 1 are not known, the amount of movement of the optical element 1 in response to the input to the position adjustment mechanisms 3 cannot be estimated, and nor the amount of change in aberration accompanying the movement of the optical element 1 can be estimated. In other words, in the first position adjustment, the value to be input to the position adjustment mechanisms 3 to settle aberration within the tolerance is not known.

Therefore, in aberration measurement and position adjustment of the optical element 1, the aberration adjustment is repeatedly performed while estimating an input to be given to the position adjustment mechanisms 3 based on the input to the position adjustment mechanisms 3 and a result of aberration change in the last adjustment cycle, thus settling aberration within the tolerance.

Before position adjustment, although the position of the optical element 1 within a positional range defined relative to the supporting member 2 is not known, the optical element 1 must be disposed within an aberration measurable range.

The positional range of the optical element 1 is defined relative to the supporting member 2 in terms of clearances between the position adjustment mechanisms 3 and the optical element 1. Therefore, the position adjustment mechanisms 3 may be attached by controlling the clearances such that the optical element 1 may not be displaced out of the aberration measurable range even if the optical element 1 is displaced within the positional range.

Methods for managing clearances includes a method for using a clearance adjustment shim, an assembly method with temperature difference management, an assembly method with pressing force management, a method for producing a predetermined amount of plastic deformation of members by using a specified pressing force, and an assembly method with an input given to the position adjustment mechanisms 3. Any one of these methods can be used separately, or a plurality thereof can be used in combination.

Since the position of the optical element 1 within the positional range defined relative to the supporting member 2 is not known, it is also possible to give a predetermined input to the position adjustment mechanisms 3 before the first aberration measurement in order to specify a position at which a certain input was given to the position adjustment mechanisms 3 as an initial position.

In this case, it is known that aberration measurement has been performed when the optical element 1 is at a position adjusted by giving a predetermined input to the position adjustment mechanisms 3. Therefore, an input to be given to the position adjustment mechanisms 3 satisfying required moving direction and amount of movement of the optical element 1 can be determined in consideration of an input given to the position adjustment mechanism 3 before aberration measurement.

In the case of a projection optical system having undergone the former aberration adjustment, an input given to the position adjustment mechanisms 3 in the former adjustment can be utilized. More specifically, after repeatedly performing the aberration measurement referring to the previous aberration measurement result, it is useful to record the latest input given to the position adjustment mechanisms 3 with which the aberration can be settled within the tolerance, and to give the recorded input to the position adjustment mechanisms 3 before aberration measurement for the following measurement.

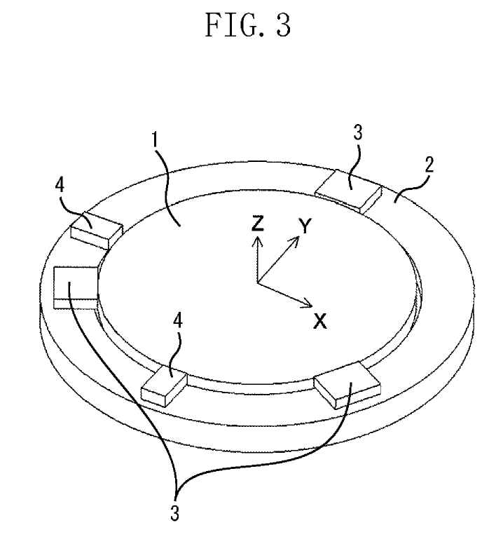

An exposure apparatus according to a third exemplary embodiment of the present invention is described below with reference to FIG. 3. The exposure apparatus according to the present exemplary embodiment includes displacement sensors 4 capable of measuring a moving direction and an amount of movement of the optical element 1.

The position detection units include a plurality of displacement sensors 4 capable of measuring at least two axes. Referring to values output from displacement sensors 4, the position detection units displace the optical element 1 relative to the supporting member 2 based on the amount of movement of the optical element 1 necessary to settle the aberration within the tolerance. The amount of movement is calculated from a result of the aberration measurement by the projection optical system 83.

More specifically, the displacement sensors 4 capable of measuring displacement of two freedom degrees in a plane perpendicularly intersecting the direction of gravitational force are disposed at two different positions on the supporting member 2. When the displacement sensors 4 are non-contact sensors, a target is attached to the optical element 1 (measurement target). When the displacement sensors 4 are optical sensors for detecting a reflected light, a plane facing the sensors may be provided on the optical element 1, and a reflection film may be provided on the plane to integrate the target and the optical element 1.

In the present exemplary embodiment illustrated in FIG. 3, the position adjustment of the optical element 1 can be performed referring to values output from the displacement sensors 4. Therefore, position adjustment of the optical element 1 can be performed while checking an actual amount of movement with respect to the amount of movement of the optical element 1 necessary to settle the aberration within the tolerance. The amount of movement is calculated from the result of aberration measurement by the projection optical system.

In the third exemplary embodiment, the number of measurements of aberration can be reduced. Accordingly, adjustment of the optical element 1 can be performed in a shorter time than a case without the displacement sensors 4.

The displacement sensors 4 in FIG. 3 are provided with an origin used as a reference for measuring an absolute position of an object under measurement. When the optical element 1 is displaced, the optical element 1 is returned to the position before displacement by referring to this origin.

More specifically, when the displacement sensors 4 are provided with an origin function, the origin function can be used to return the optical element 1 to the former position. The origin of the displacement sensors 4 is a reference used by the displacement sensors 4 to measure an absolute position of an object under measurement. Absolute displacement of the object under measurement is measured in terms of displacement with reference to the origin.

The following describes a case where, after position adjustment of the optical element 1 has been performed so that the aberration falls within the tolerance, the position of the optical element 1 relative to the supporting member 2 is recorded as an origin (reference) and then the position of the optical element 1 is determined to have been displaced during transportation and operation.

In this case, by using the position adjustment mechanisms 3, the optical element 1 is returned to the position before displacement with reference to the origin of the displacement sensors 4. When adjustment for settling aberration within the tolerance is performed again, the position recorded with reference to the origin is updated to reflect the latest adjustment result.

With the method for using the origin of the displacement sensors 4, when displacement of the optical element 1 arises, the displacement can be corrected without aberration measurement.

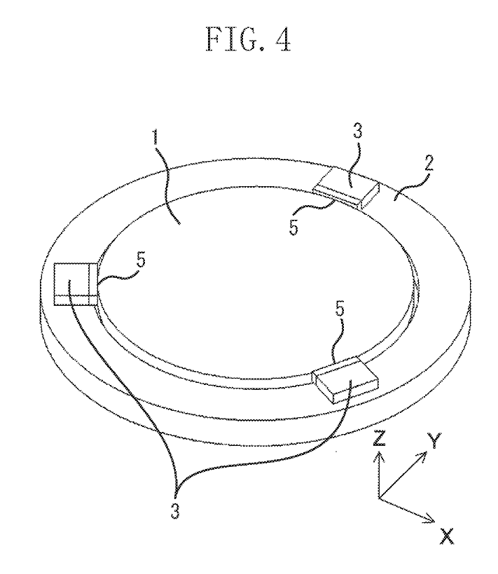

An exposure apparatus according to a fourth exemplary embodiment is described below with reference to FIG. 4. The exposure apparatus according to the present exemplary embodiment is provided with contact detection units 5 at contact positions respectively between the position adjustment mechanisms 3 and the optical element 1.

The exposure apparatus according to the fourth exemplary embodiment includes the contact detection units 5 such as contact detection sensors disposed at contact portions respectively between the position adjustment mechanisms 3 and the optical element 1 and configured to detect the contacts therebetween. After the contact detection units 5 detect contacts therebetween, an input given to the position adjustment mechanism 3 as a command value determines an amount of movement of the optical element 1.

Although the contact detection units 5 are disposed on the position adjustment mechanism 3 at contact positions between the position adjustment mechanisms 3 and the optical element 1, they may be disposed on the side of the optical element 1.

When the contact detection units 5 are pressure sensors, they may be disposed at other than the contact positions between the contact detection units 5 and the optical element 1 as long as they can detect pressure generated when the position adjustment mechanisms 3 press the optical element 1. Since the contact detection units 5 can detect contacts between the position adjustment mechanisms 3 and the optical element 1, the amount of movement of the optical element 1 is determined from the command value input to the position adjustment mechanisms 3 after the contact.

With the exposure apparatuses according to the first, second, third, and fourth exemplary embodiments of the present invention illustrated respectively in FIGS. 1, 2, 3, and 4 factors such as shock or temperature change may cause a positional deviation of the optical element 1 relative to the supporting member 2.

In this case, a positional deviation is detected by aberration measurement of the projection optical system or by the position detection units (the displacement sensors 4), and the position adjustment mechanisms 3 adjust the position of the optical element 1 so that the predetermined optical performance is obtained.

The optical element 1 is adjusted by the position adjustment mechanisms 3 based on a measurement result by the position detection units at the time of assembly and adjustment of the exposure apparatus, installation after transportation, and performance check after starting operation.

The performance check after starting operation refers to periodical performance check and other performance checks performed if a displacement sensor, an accelerometer, or a thermometer disposed in the exposure apparatus, for example, included in the projection optical system 83 detects a change exceeding a specified value. These performance checks correct degradation in optical performance caused by a positional deviation of the optical element relative to the supporting member 2, thus providing stable optical performance over long periods.

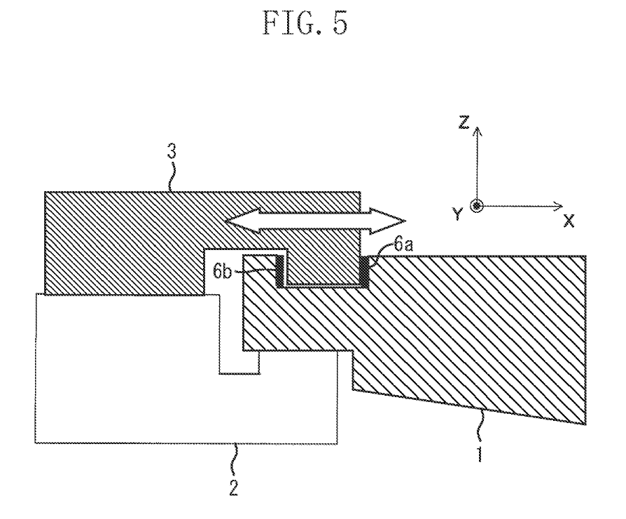

An exposure apparatus according to a fifth exemplary embodiment is described below with reference to FIGS. 5 and 6. The exposure apparatus according to the present exemplary embodiment includes two different contact positions between the position adjustment mechanisms 3 and the optical element 1. The position adjustment mechanisms 3 displace the optical element 1 in positive and negative directions along the direction in which the position adjustment mechanisms 3 move.

The exposure apparatus includes two different contact positions between the position adjustment mechanisms 3 and the optical element 1, and at least two position adjustment mechanisms 3 that can displace the optical element 1 in positive and negative directions. The contact positions between the position adjustment mechanisms 3 and the optical element 1 are moved to press the optical element 1 to displace it relative to the supporting member 2, thus performing optical performance adjustment of the optical element 1, and then make all the position adjustment mechanisms 3 not in contact with the optical element 1.

The optical element 1 has a concave portion and a position adjustment mechanism 3 has a convex portion, and vice versa. As the position adjustment mechanism 3 is displaced in positive direction along the X axis, the position adjustment mechanism 3 comes in contact with the optical element 1 at a contact position 6a thereof, and the optical element 1 is displaced in positive direction of the X axis. On the contrary, when the position adjustment mechanism 3 is displaced in negative direction of the X axis, the position adjustment mechanism 3 comes in contact with the optical element 1 at a contact position 6b thereof, and the optical element 1 is displaced in negative direction of the X axis.

Upon completion of position adjustment, an input is given to the position adjustment mechanism 3 to make both the contact positions 6a and 6b not in contact with the position adjustment mechanism 3.

The position adjustment mechanism 3 can displace the optical element 1 in both positive and negative directions. Therefore, as illustrated in FIG. 6, the optical element 1 can be displaced in any directions in a plane perpendicularly intersecting the direction of gravitational force by position adjustment mechanisms 3 disposed at two different positions or more other than opposite positions with respect to the central axis of the optical element 1.

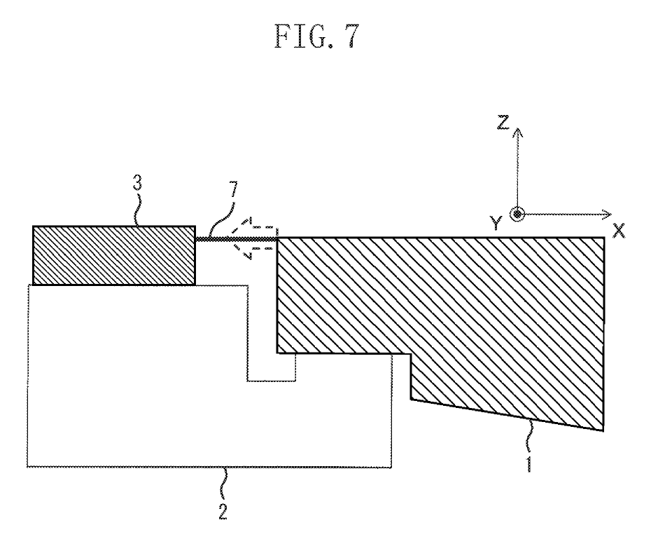

To reduce influence of external force when fixing the optical element 1 or performing position adjustment thereof, fixing members are not used. Instead, after position adjustment of the optical element 1, the position detection units make the position adjustment mechanisms 3 not in contact with the optical element 1. However, an exposure apparatus according to a sixth exemplary embodiment of the present invention illustrated in FIG. 7 can also sufficiently reduce influence of external force. The exposure apparatus according to the present exemplary embodiment includes a coupling member 7 for connecting one position adjustment mechanism 3 with the optical element 1.

The contact positions of the position adjustment mechanism 3 formed between the position adjustment mechanisms 3 and the optical element 1 is moved to press the optical element 1 to displace it relative to the supporting member 2, thus performing optical performance adjustment of the optical element 1, and then make all the position adjustment mechanisms 3 not in contact with the optical element 1.

More specifically, when the position adjustment mechanism 3 is moved in negative direction along the X axis, the optical element 1 is pulled by the position adjustment mechanism 3 via the coupling member 7, and accordingly the optical element 1 is displaced in negative direction of the X axis.

As the coupling member 7 a wire may be used, which is rigid in the direction in which the position adjustment mechanism 3 pulls the optical element 1, but is very weak in at least one direction perpendicularly intersecting the pulling direction. Upon completion of position adjustment of the optical element 1 by pulling the optical element 1, the position adjustment mechanism 3 is moved in positive direction of the X axis to press the coupling member 7 to bend it. Thus, the force applied to the optical element 1 is sufficiently reduced.

Therefore, even if the coupling member 7 is present, which is in contact with the optical element 1 in the moving direction of the optical element 1, optical performance adjustment of the optical element 1 can be performed with high precision, thus providing stable optical performance over long periods.

By using an exposure apparatuses according to any one of the above-mentioned exemplary embodiments, a device (a semiconductor integrated circuit element, a liquid crystal display element, etc.) is formed and manufactured through a process of exposing a substrate (a wafer, a glass plate, etc.) on which sensitive agent is applied, and a process of developing the exposed substrate. A process for processing the developed substrate includes etching, resist separation, dicing, bonding, and packaging.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-308733 filed Dec. 3, 2008, which is hereby incorporated by reference herein in its entirety.

What is claimed is:

1. An apparatus comprising:
a supporting member configured to support an optical element of a projection optical system along a direction of gravitational force; and
position adjustment mechanisms disposed at a plurality of positions on the supporting member and configured to press the optical element, with a pressing force, to displace the optical element relative to the supporting member,
wherein after the pressing force is changed to move contact positions between the position adjustment mechanisms and the optical element and optical performance measurement of the optical element is performed, all the position adjustment mechanisms are made in a non-contact state with the optical element.

2. The exposure apparatus according to claim 1, wherein the position adjustment mechanisms press the optical element toward a central axis.

3. The exposure apparatus according to claim 1, further comprising position detection units configured to detect an amount of movement of the optical element.

4. The exposure apparatus according to claim 1, wherein the position adjustment mechanisms are thermal actuators controlled by a temperature control unit, and the thermal actuators move the contact positions between the thermal actuators and the optical element by a volume change in the thermal actuators caused by a temperature change.

5. The exposure apparatus according to claim 1, wherein each of the position adjustment mechanisms includes an actuator and a link mechanism for changing magnification and direction of displacement of the actuator, and
wherein the link mechanism is brought into contact with the optical element.

6. The exposure apparatus according to claim 3, wherein the position detection units measure aberration of the projection optical system, calculate an amount of movement of the optical element necessary to settle the aberration within a tolerance, and displace the optical element relative to the supporting member.

7. The exposure apparatus according to claim 3, wherein the position detection units include a plurality of displacement sensors capable of measuring at least two axes, and
wherein, referring to values of displacement sensors, the optical element is displaced relative to the supporting member based on the amount of movement of the optical element necessary to settle the aberration within a tolerance, which is calculated from a result of aberration measurement by the projection optical system.

8. The exposure apparatus according to claim 7, wherein the displacement sensors are provided with an origin used as a reference for measuring an absolute position of an object to be measured, and, when the position of the optical element is displaced, the optical element is returned to the position before displacing the optical element with reference to the origin.

9. The exposure apparatus according to claim 1, further comprising:
contact detection units disposed at contact portions between the position adjustment mechanisms and the optical element and configured to detect contact therebetween,
wherein, after the contact detection units detect contact, an input given to the position adjustment mechanisms as a command value determines an amount of movement of the optical element.

10. The apparatus according to claim 1 further comprising
position detection units configured to detect an amount of movement of the optical element,
wherein the position adjustment mechanisms are provided with two different contact positions with the optical element to displace the optical element in both positive and negative directions.

11. The exposure apparatus according to claim 1 further comprising:
position detection units each configured to detect an amount of movement of the optical element; and
coupling members each configured to connect the position adjustment mechanisms with the optical element,
wherein after contact positions between the position adjustment mechanisms and the optical element are moved in one and opposite directions to respectively press and pull the optical element, the coupling members are bent.

12. A method for manufacturing a device by exposing a substrate using an apparatus including;
a projection optical system configured to project a pattern of an original plate onto a substrate to expose the substrate to the pattern,
a supporting member configured to support an optical element of the projection optical system along a direction of gravitational force, and
position adjustment mechanisms disposed at a plurality of positions on the supporting member and configured to press the optical element, with a pressing force, to displace the optical element relative to the supporting member,
the method comprising:
changing the pressing force to move contact positions between the position adjustment mechanisms and the optical element;
performing optical performance measurement of the optical element;
making all the position adjustment mechanisms in non-contact state with the optical element; and
developing the exposed substrate.

13. A method for manufacturing a device by exposing a substrate by using an exposure apparatus including;
a projection optical system configured to project a pattern of an original plate onto a substrate to expose the substrate to the pattern,
a supporting member configured to support an optical element of the projection optical system along a direction of gravitational force,
position adjustment mechanisms disposed at a plurality of positions on the supporting member and configured to press the optical element to displace the optical element relative to the supporting member, and
position detection units configured to detect an amount of movement of the optical element,
wherein the position adjustment mechanisms are provided with two different contact positions with the optical element to displace the optical element in positive and negative directions, and
the method comprising:
moving contact positions between the position adjustment mechanisms and the optical element to displace the optical element relative to the supporting member;
performing optical performance measurement of the optical element;
making all the position adjustment mechanisms in non-contact state with the optical element; and
developing the exposed substrate.

14. The method according to claim 13, wherein the apparatus further including coupling members configured to connect the position adjustment mechanisms with the optical element, and
wherein the moving contact positions between the position adjustment mechanisms and the optical element is in one and opposite directions to respectively press and pull the optical element to displace the optical element relative to the supporting member.
